(19) United States
(12) Patent Application Publication
(10) Pub. No.: US 2024/0059524 A1
(43) Pub. Date: Feb. 22, 2024

(54) Contactless Elevator Buttons and Method of Controlling the Same

(71) Applicant: PROX SG Pte Ltd, Singapore (SG)

(72) Inventors: Mikhail KOLOBOV, Singapore (SG); Oleg KOLOBOV, St. Petersburg (RU); Aleksandr PLATONOV, St. Petersburg (RU)

(73) Assignee: PROX SG Pte Ltd, Singapore (SG)

(21) Appl. No.: 18/449,720

(22) Filed: Aug. 15, 2023

(30) Foreign Application Priority Data
Aug. 18, 2022 (SG) 10202250762T

(51) Int. Cl. B66B 1/46; B66B 1/52

(52) U.S. Cl. CPC B66B 1/461; B66B 1/52; B66B 2201/4623; B66B 2201/4638

(57) ABSTRACT

The present invention provides an elevator button kit for adding contactless sensing to control operations of an elevator though an elevator controller. The elevator button kit comprises a plurality of buttons and a bus. Each button comprises a primary switch for directly controlling the elevator controller, wherein the primary switch requires physical contact to the button to trigger the same; a secondary switch adapted to be triggered electronically; a position sensor for sensing presence of objects within a sensing range; and a microcontroller (MCU) having both the position sensor and the secondary switch connected thereto. The bus connecting the MCUs of the plurality of the buttons to form a MCU network, wherein operationally, range data from each position sensor is acquired by the connected MCU and broadcasted to the other MCUs through the MCU network, and each MCU processes the collected range data from the MCU network to determine whether to send a trigger signal to activate the connected secondary switch to control the elevator controller. A method thereof is also provided.

### FIELD OF THE INVENTION

The present invention relates to elevator buttons. More specification, the present invention relates to an elevator button upgrade kits for all exiting elevator installations and method of controlling the same.

### BACKGROUND

In urban area where multi-stories/high-rise residential and commercial buildings are increasingly populated, usage of elevators is unavoidable, and in many cases, several times daily. Usage of elevators requires physically pressing the elevator buttons on the elevators to bring them to the floor/level of desires. These elevators constantly used by the public and the buttons on the panel are frequently touched by the passengers throughout the day. Unless it is frequently cleaned and sanitized, passengers are exposed to the risks of getting infected by the bacteria, viruses, germs and/or diseases left by the earlier passengers.

In a typical case, an elevator system comprises hall buttons at each floor used by users for calling elevator car and floor buttons in each elevator cars for floor selections. Most of these buttons are push button where user is required to physically push or press the button to trigger the same. Each of these buttons is individually connected to a lift controller, and when any of these buttons is pushed or pressed, a signal corresponds to that button is sent to the elevator controller to execute the corresponding operation.

It is well known in the art that the elevator controller executes upon detecting any key pressed, regardless of whether it is intended or fault trigger.

The elevator controller may be any of relay-based controller, solid state logic technology, computer-based controller such as PLC or the like, which is well known in the art.

There are add-on solutions available to add on touchless/contactless capability to the elevator control panel, whereby user does not need to physically touch the button to trigger it. These solutions use typically proximity sensors and/or imaging sensors to detect when an object is detected at a proximity of the respective buttons, the button(s) is triggered and executed accordingly on the elevator controller. While it is convenient to trigger the buttons without physical contact, false triggering when one or more objects, or large object within multiple sensing area can be problematic.

U.S. Pat. No. 9,463,955 discloses an elevator activation system that provide virtual activation of one or more buttons. It provides an optical imaging device configured to project “an optical curtain” covering an area of all the physical buttons on the panel of the elevator. Operationally, a sensor controller controlling the optical imaging device virtually activate at least one button based on disturbance detected in the optical curtain to determine which button to activate before even the corresponding button is pushed. Depending on the placement of the imaging device, an object within the optical curtain may block the other object that also within the range of optical curtain.

### SUMMARY

In one aspect of the present invention, there is provided an elevator button kit for adding contactless sensing to control operations of an elevator though an elevator controller. The elevator button kit comprises a plurality of buttons and a bus. Each button comprises a primary switch for directly controlling the elevator controller, wherein the primary switch requires physical contact to the button to trigger the same; a secondary switch adapted to be triggered electronically; a position sensor for sensing presence of objects within a sensing range; and a microcontroller (MCU) having both the position sensor and the secondary switch connected thereto. The bus connecting the MCUs of the plurality of the buttons to form a MCU network, wherein operationally, range data from each position sensor is acquired by the connected MCU and broadcasted to the other MCUs through the MCU network, and each MCU processes the collected range data from the MCU network to determine whether to send a trigger signal to activate the connected secondary switch to control the elevator controller.

In one embodiment, the bus is a CAN bus.

In another embodiment, the position sensor is configurable through the MCU. The position sensor may be a proximity sensor (inductive, capacitive, etc.). or a range sensor that include object distance signals.

In an alternative embodiment, the primary switch is a push switch or a tactile switch. In yet another embodiment, the primary switch is a touch sensing switch.

In a further embodiment, the secondary switch may be any of transistor-based switch, relay switch, etc.

In yet a further embodiment, the primary switch and the secondary switch may be connected in parallel to the elevator controller.

In a further embodiment, the primary switch is further connected to the MCU, whereby the MCU receive signal therefrom, if any, for processing.

In an alternative embodiment, there is also provided a method of controlling an elevator controller having contactless sensors to detect presence of objection within a sensing range. The method comprises providing each button with a microcontroller (MCU) having a secondary switch and a position sensor connected thereto, wherein the MCU operationally collects and processes data from position sensors of other buttons to trigger its own secondary switch electronically to control operations of the elevator controller; connecting the MCUs of the plurality of buttons through a bus forming a MCU network; collecting range data of the position sensor of the plurality of buttons by each MCU; transmitting range data to the other MCUs of the plurality of buttons; analyzing, by each MCU, the range data from the MCU network; and determining, by each MCU, whether to send a trigger signal to the secondary switch connected therewith.

In one embodiment, the MCU processes the range data of a group of other MCUs of the other buttons.

In another embodiment, wherein analyzing, by each MCU, the range data from the MCU network further comprises determining if the range data from its position sensor below a threshold; broadcasting, through the MCU over the MCU network, the range data from its position sensor to the MCUs of the others MCUs; receiving, through the MCU from the MCU network, the range data of position sensors of other buttons; and determining, based on collections of the range data from the MCU network, whether to trigger its own secondary switch electronically.

In yet another embodiment, the method may further comprise resetting the secondary switch of the button that are not to be triggered.

### BRIEF DESCRIPTION OF THE DRAWINGS

This invention will be described by way of non-limiting embodiments of the present invention, with reference to the accompanying drawings, in which:

FIG. 1 illustrates a schematic diagram of an elevator input control system in accordance with an embodiment of the present invention;

FIG. 2 illustrates a schematic diagram of a contactless elevator switch kit in accordance with an embodiment of the present invention; and

FIG. 3 illustrates process flow control of MCU of a button in accordance with an embodiment of the present invention.

### DETAILED DESCRIPTION

In line with the above summary, the following description of a number of specific and alternative embodiments are provided to understand the inventive features of the present invention. It shall be apparent to one skilled in the art, however that this invention may be practiced without such specific details. Some of the details may not be described at length so as not to obscure the invention. For ease of reference, common reference numerals will be used throughout the figures when referring to the same or similar features common to the figures.

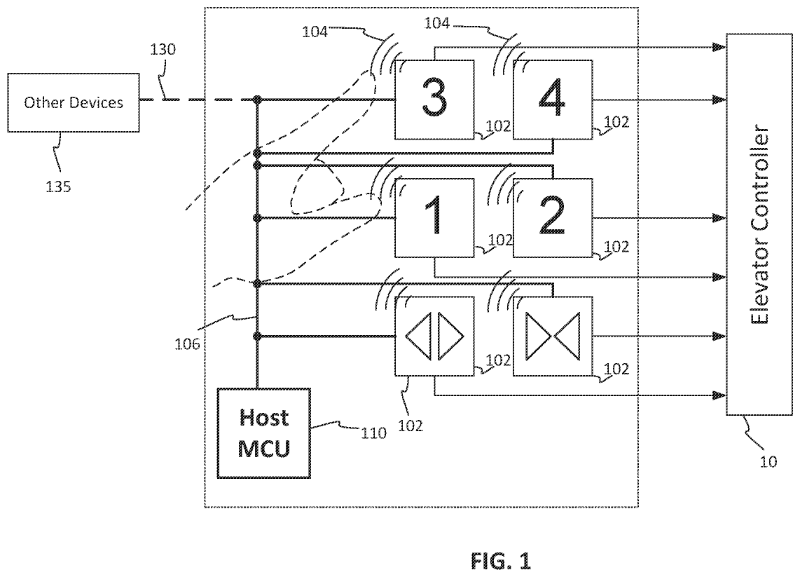

FIG. 1 illustrates a schematic diagram of an elevator input control system 100 in accordance with an embodiment of the present invention. The elevator input controller system 100 comprises a plurality of the buttons 102, position sensors, a host microcontroller (MCU) 110 and a bus 106. When installed, the buttons 102 can be triggered by physically touching/pressing the buttons 102 and it can also be triggered contactlessly (i.e. without any physical contact).

For physical touch/press triggering, each button 102 comprises a primary switch (not shown) which is individually connected to an elevator controller 10 of an elevator, whereby physical contact with the button 102 triggers the push switch to send triggering signal to the elevator controller 10 to control the elevator. The primary switch can be a mechanical switch, such as push button or tactile switch that require physical contact to trigger the switch. In another embodiment, the primary switch can be a touch sensing switch. For contactless triggering, each of the buttons 102 further provides a secondary switch that includes position sensors, wherein the position sensors and the secondary switch are both connected to the host microcontroller (MCU) 110 through the bus 106. The secondary switch is controllable by the host MCU 110 electronically based on detections by the position sensor within its sensing range 104. Each of the position sensors has its own sensing range 104 for each button 102. Operationally, the MCU 110 collects all the signals from all position sensors through the bus 106 for processing to decide the button(s) 102 to be triggered.

For clarity, the primary switch of the buttons 102 is activated only through physical contact. The secondary switch of the buttons 102 is distinguishable from the primary switch in that the secondary switch is controlled by the host MCU 110, whereby activation of the secondary switches is only by the host MCU 110. In the present embodiment, the secondary switches are electronic switches that operationally controllable by the host MCU 110.

In the embodiment of the present invention, the position sensor can be any object detection means adapted is adopted for detecting presence of any objection entering its sensing range without any physical contact, hence touchless sensing. The position sensor can be a proximity sensor, range sensor or the like. Data/signal collected from the position sensors, such as range and time stamps, are collectively processed by the host MCU 110 to determine the secondary switch to be triggered, or not. According to the embodiments of the present invention, the position sensor may include a range sensor that provide distance information as parameters for processing. By processing all the position sensor's data, the host MCU 110 may further determine if there are any false triggering. If the host MCU 110 detects false triggering on one or more buttons 102, no triggering signal is sent to trigger the corresponding secondary switch. The host MCU 110 actively process all the data from the position sensors to determine for appropriate response.

In one embodiment, the host MCU 110 comprises a plurality of discrete MCUs, one for each button. Each discrete MCU is connecting between the respective position sensor and the bus 106, wherein each discrete MCU operationally receives signals from the position sensor connected thereto and broadcast the messages over the network to the other MCUs and receives messages sent by other buttons from the network for processing to determine whether to trigger any button(s) 102.

The primary switches are generally push button/switch such as tactile switch or any biased switches that requires physical contact to trigger the switches for activating the users' selections. In another embodiment, the primary switches can be touch sensitive electronic switch well known in the art.

In one embodiment, the position sensor can be a proximity sensor for detecting object in range. In yet another embodiment, the position sensor can be any range/proximity sensor for detecting object presence with distance information, or an imaging sensor for capturing live feed for determining types of objects in range, among other parameters.

In one embodiment, the buttons 102 together with the host MCU 110 and the bus 106 are bundled as an elevator button kit for installation to any existing elevator as replacement to add contactless ability. In one embodiment, each button 102 comprises one connector for interfacing to the bus 106, and another connector for connecting to the elevator connector 10.

In one further embodiment of the present invention, the bus 106 may further facilitate connections 130 to interface with other devices 135 to be connected thereto for any possible expansions. The devices 135 connected to the bus may operationally communicate with the MCU(s) for additional functionalities. In one exemplified embodiment, the device 135 may be a wireless communication module, such as Bluetooth module, and with the relevant applications, the elevator may become a smart elevator. In another example, the device 135 may be an imagining device, which may process and feed data to the MCU(s) to improve the processing results to trigger the switch. In yet another embodiment, the smart elevator may be adapted with voice command.

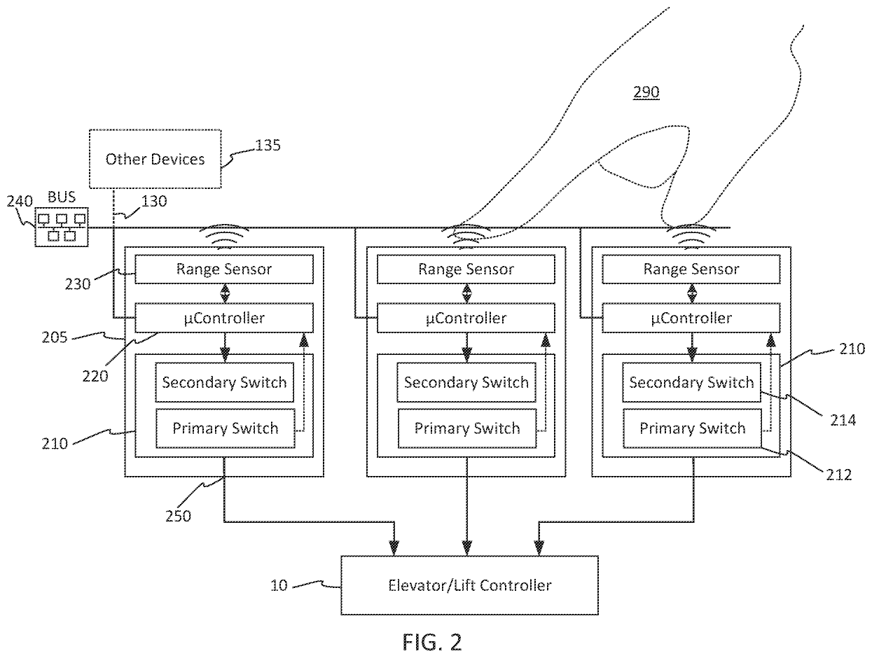

FIG. 2 illustrates a schematic diagram of a contactless elevator switch kit 200 in accordance with an embodiment of the present invention. The contactless elevator switch kit 200 is adapted to be deployed over any existing or new elevator switch's panel as replacement buttons or new installations.

The contactless elevator switch kit 200 comprises a bus 240 and a plurality of buttons 205. The buttons 205, each comprises a position sensor 230, a microcontroller (MCU) 220 and a switch 210. The data bus 240 connects all the MCUs 220 directly forming a bus network. Each position sensor 230 and the switch 210 are connected directly to a respective MCU 220, such that each MCU 220 receives signals from position sensor 230 to determine whether to trigger the switch 210 or not. Each switch 210 may further comprises a physical connector 250 for respectively connect to a corresponding channel of the elevator controller 10 whereby triggering signals from the MCU 220 can be sent to the elevator controller 10 through the switch 210.

The position sensor 230 is disposed adjacent to a button face cover (not shown) of the button 205 for sensing objects within its sensing range. The button face cover is a labeled piece where users of the elevator touch to activate the button to controller the elevator. The position sensor 230 is added under the button face cover such that the button 205 can be activated without having the need of any physical contact with the button 205.

In one embodiment, each MCU 220 is integrated under one button 205 and connected to one position sensor 230. The button 205 include a primary switch 212 and a secondary switch 214 connecting in parallel to the elevator controller 10. Accordingly, either the primary switch 212 or the secondary switch 214 may trigger the elevator controller 10 to operate the elevator. In this embodiment, the primary switch 212 may be a mechanical switch or touch sensing switch that requires physical touch to trigger the switch 210. The secondary switch 214 is an electronic switch that connected and controllable by the MCU 220. The electronic switch may be a transistor-based switch, relay, etc. controllable by the MCU 220.

Operationally, the MCU 220 can be used for configuring the position sensor 230 and receiving signals from the position sensor 230. The signals from the position sensor 230 are processed by the MCU 220 to determine whether to output any toggling signals to the secondary switch 214.

The bus network connects all the MCUs 220 of the buttons 205 so that the MCUs 220 are in communication with each other. Operationally, the MCUs 220 broadcast messages over the bus network in real time. The message includes live feed data from the respective position sensor 230. It is desired that each MCU 220 processes the data independently to control their respective electronic switch 210.

In a further embodiment, the primary switch 212 may further connect to the MCU 220, whereby when the primary switch 212 is triggered, a separate signal is sent to the MCU 220, which is further broadcast to the MCU network for processing. Specifically, when the primary switch 212 is triggered, in one embodiment, the MCUs 220 shall be taken with priority and override signals from the position sensors 230.

In one embodiment, the bus 240 include a Controller Area Network (CAN) bus for connecting the MCUs 220 forming an independent communication network.

Operationally, the position sensors 230 is actively sensing for any objects within its sensing range and the respective position sensor 230 reports the sensing results to its MCU 220 connected thereto. The MCU 220 then broadcasts the sensed results of its position sensor 230 to the other MCU 220 and further acquires sensed results of the other position sensors 230 from the other MCU 220. In such arrangements, all MCUs 220 are synchronized on all the sensing results from all the position sensors 230 for processing in real-time. The MCUs 220 independently processed the sensed results from the position sensors 230, and if conditions are met, the MCUs 220 send a trigger signal to activate the secondary switch 214, which in turn trigger the elevator controller 10, i.e. contactless switching.

The contactless elevator switch kit 200 is adapted for installing over any existing elevator to provide contactless trigger. Each button of the switch kit 200 comprises a microprocessor and a connected position sensor to perform contactless sensing, whereby the range data of all position sensors are broadcast to the MCUs' network connected through the bus. Each MCU independently processed all the collected range data (including its own) to determine if its corresponding switch should be activated. If it is activated, the trigger signal is sent through the corresponding switch to the elevator controller 10.

As shown in FIG. 2, a hand finger 290 is advancing towards a desired button to activate. When the position sensor 230 of the designated button detects an object (the finger) is within its sensing range without any physical contact, the MCU 220 of that position sensor 230 broadcasts its range data to the MCU network. If no other position sensor is detecting any object within sensing range, MCU of that position sensor sends a trigger signal to its switch, which in turn send to the elevator controller 10 as if the switch is activated physically.

In case when the hand oriented in such a way that other fingers are also sensed by the other position sensor(s) 230, the MCUs 220 may just ignore the other position sensor(s) 230 and activate only the first position sensor 230 that detects finger in range.

Similarly in the embodiments of FIG. 2, the bus 240 may further comprise an expansion interface that offer connections 130 to other devices 135.

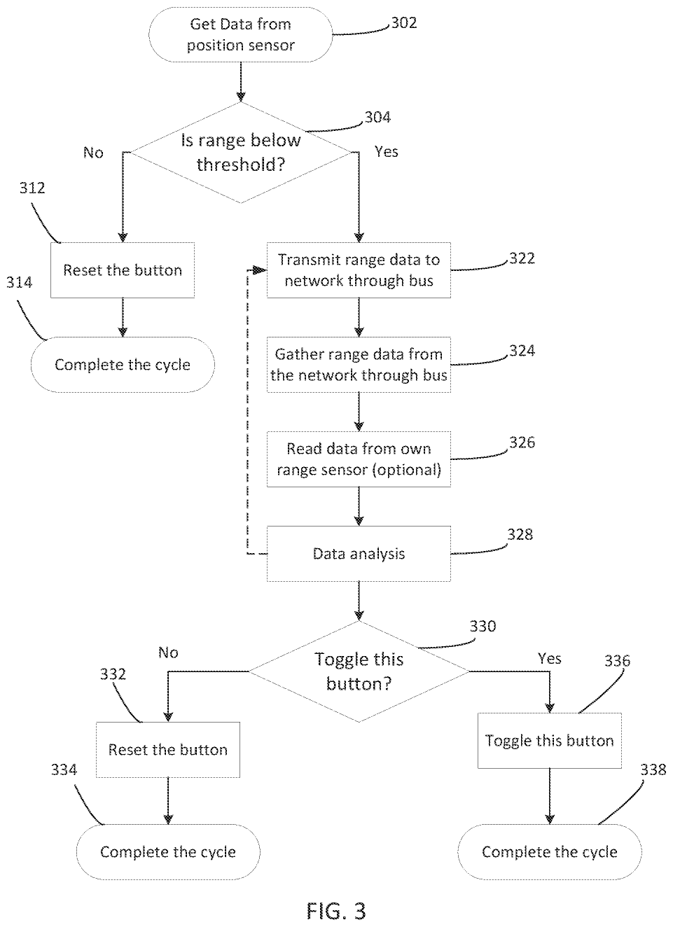

FIG. 3 illustrates process flow control 300 of controller network in accordance with an embodiment of the present invention. At step 302, the process starts with receiving (range) data or signal from the position sensor 230. At step 304, the MCUs 220 determine if the range below a predefined threshold. If the range is above the threshold, i.e. not below threshold, at step 312, the MCU 220 reset the secondary switch 214 and at step 314, it complete the processing cycle.

Referring back to the step 304, when the range/position is below the predefined threshold, at step 322 MCU 220 transmit the range data across the network through the bus 240. At step 324, the MCUs 220 gather data from the MCU 220 from other secondary switch 214 of buttons 205 across the bus network so that each MCU 220 possesses its own data from the position sensor and from other MCUs 220 for processing. It is desired that the gathered range data is stored and kept for a prescribe period for MCUs' processing. At step 326, the MCU 220 reads current range data from its position sensor 230. In one embodiment, the step 326 is optional. At step 328, the MCU 220 performs a data analysis based on the range data collected from its own position sensor and the bus network (others position sensors 230) within the prescribed period.

The data analysis gathered the range data for the prescribed period to determine whether to activate the secondary switch 214 of the button 205 at step 330, or not.

If the MCU 220 determines not to activate the corresponding secondary switch 212 of button 205 at step 330, the secondary switch is reset at step 332 and at the cycle is completed at step 334. If the MCU 220 determines the secondary switch 214 of the button 205 is to be activated contactlessly, at step 336, the secondary switch 214 of the button 205 is triggered. The secondary switch 214 of the button 205 is activated through the MCU 220.

In another embodiment, the steps 322-328 are repeated for several rounds before activating/resetting secondary switches 214 of the buttons 205. This loop is provided to collect sufficient useful data for making the decisions. For clarify, resetting the secondary switch 214 of the button 205 may include forcing the secondary switch 214 to off state.

In a further embodiment, the process further includes receiving signals from the primary switch 212 of each button 205 by the MCUs 220, if any, such that the data analysis by the MCUs 220 includes signals from the primary switch 212 to determine the button to be triggered to control the elevator controller 10.

In one embodiment, the data analysis includes comparing its own range data against that of the other buttons 205. It may further include a process of calculating the range data from all or selected group of the buttons 205 to determine a button to be activated. These processing is to eliminate unintended buttons to be activated. The range data may include direction of object(s) in the vicinity of the button relative to the others, the range data of the same button within at different times, speed of the moving object, time spent by the objection in the vicinity of the sensor range, etc. The range data can be of the range data detected by one button alone, or collective range data of the entire or group of the MCU network.

While specific embodiments have been described and illustrated, it is understood that many changes, modifications, variations and combinations thereof could be made to the present invention without departing from the scope of the invention.

1. An elevator button kit for adding contactless sensing to control operations of an elevator though an elevator controller, the elevator button kit comprising:
a plurality of buttons, each button comprising:
a primary switch for directly controlling the elevator controller, wherein the primary switch requires physical contact to the button to trigger the same;
a secondary switch adapted to be triggered electronically;
a position sensor for sensing presence of objects within a sensing range; and
a microcontroller (MCU) having both the position sensor and the secondary switch connected thereto; and
a bus connecting the MCUs of the plurality of the buttons to form a MCU network,
wherein operationally, range data from each position sensor is acquired by the connected MCU and broadcasted to the other MCUs through the MCU network, and
each MCU processes the collected range data from the MCU network to determine whether to send a trigger signal to activate the connected secondary switch to control the elevator controller.

2. The elevator button kit according to claim 1, wherein the bus is a CAN bus.

3. The elevator button kit according to claim 1, wherein the position sensor is configurable through the MCU.

4. The elevator button kit according to claim 1, wherein the position sensor is a proximity sensor (inductive, capacitive, etc.).

5. The elevator button kit according to claim 1, wherein the position sensor is a range sensor that include object distance signals.

6. The elevator button kit according to claim 1, wherein the primary switch is a push switch.

7. The elevator button kit according to claim 1, wherein the primary switch is a tactile switch.

8. The elevator button kit according to claim 1, wherein the primary switch is a touch sensing switch.

9. The elevator button kit according to claim 1, wherein the secondary switch is any of transistor-based switch, relay switch, etc.

10. The elevator button kit according to claim 1, wherein the primary switch and the secondary switch are connected in parallel to the elevator controller.

11. The elevator button kit according to claim 1, wherein the primary switch is further connected to the MCU, whereby the MCU receive signal therefrom, if any, for processing.

12. The elevator button kit according to claim 1, wherein the bus further comprises expansion interface for connecting to other devices/module, such as a wireless communication module.

13. A method of controlling an elevator controller having contactless sensors to detect presence of objection within a sensing range, the method comprising:
providing each button with a microcontroller (MCU) having a secondary switch and a position sensor connected thereto, wherein the MCU operationally collects and processes data from position sensors of other buttons to trigger its own secondary switch electronically to control operations of the elevator controller;
connecting the MCUs of the plurality of buttons through a bus forming a MCU network;
collecting range data of the position sensor of the plurality of buttons by each MCU;
transmitting range data to the other MCUs of the plurality of buttons;
analyzing, by each MCU, the range data from the MCU network; and
determining, by each MCU, whether to send a trigger signal to the secondary switch connected therewith.

14. The method of claim 13, wherein the MCU process the range data of a group of other MCUs of the other buttons.

15. The method of claim 13, wherein analyzing, by each MCU, the range data from the MCU network further comprising:
determining if the range data from its position sensor below a threshold;
broadcasting, through the MCU over the MCU network, the range data from its position sensor to the MCUs of the others MCUs;
receiving, through the MCU from the MCU network, the range data of position sensors of other buttons; and
determining, based on collections of the range data from the MCU network, whether to trigger its own secondary switch electronically.

16. The method of claim 15, further comprises resetting the secondary switch of the button that are not to be triggered.
